(19) United States
(12) Patent Application Publication
(10) Pub. No.: US 2024/0005718 A1
(43) Pub. Date: Jan. 4, 2024

(54) Access Management Through Property Management Portal

(71) Applicant: Smartz Inc., Champaign, IL (US)

(72) Inventors: Ramesh Babu Kuttuboina, Champaign, IL (US); Kevin Kelin Wan, Champaign, IL (US)

(73) Assignee: Smartz Inc., Champaign, IL (US)

(21) Appl. No.: 17/810,343

(22) Filed: Jul. 1, 2022

(51) Int. Cl. G07C 9/37; G07C 9/38; G06Q 50/16

(52) U.S. Cl. CPC G07C 9/37; G07C 9/38; G06Q 50/163

(57) ABSTRACT

The present invention disclosed is access management for properties through a property management portal/software. Access management for a property means giving tenants or property staff access to common entry doors, garage doors, entry gates, unit doors, secure rooms, etc. There are various categories of access such as vehicle, tenant, staff, visitor, and vendor access. Each type of access has a specific time range of allowable access such as one-time, specific time, unlimited, or lifetime access. Technology that supports access management ranges from license plate readers, image recognition, proximity detection, or biometrics.

### BACKGROUND OF THE INVENTION

The invention belongs to the PropTech industry especially related to property management software technology.

There are a growing number of smart electronic devices connected to the internet. The rapid adaption of these devices by people to make their homes or apartments smarter is growing exponentially every year. It is important to think about how current property management software could be transformed through smart device integration.

Security is one of the criteria that tenants look for when choosing an apartment. Property owners and managers are aware that the number of thefts and crimes is increasing across apartment communities. Security cameras are smart devices that can help to monitor ongoing activities, but don't prevent access to the property.

Current property management software/portals in the PropTech industry focus more on generic property management features such as rental payments, leasing, move-in/move-out, maintenance tickets, and property listing features but do not provide access control through their software.

### SUMMARY OF THE INVENTION

Multifamily properties can host numerous smart home devices such as leak detectors, security cameras, thermostats, smart lighting, door locks, and more. Currently, property managers use various vendors to manage each device. Property managers typically also use a variety of property management software platforms to manage rental, maintenance, and other property-related issues.

To solve this problem, we have come up with an all-in-one property management software solution where all smart devices are managed through a single portal along with common property management features like rental payments, leasing, maintenance, and more.

### BRIEF DESCRIPTIONS OF THE DRAWINGS

FIG. 1 schematically illustrates an example management portal architecture of the present invention.

FIG. 2 schematically illustrates an example management portal application interface of the present invention.

FIG. 3 schematically illustrates an example management portal vehicle access workflow of the present invention.

FIG. 4 schematically illustrates an example management portal individual access workflow of the present invention.

### DETAILED DESCRIPTION

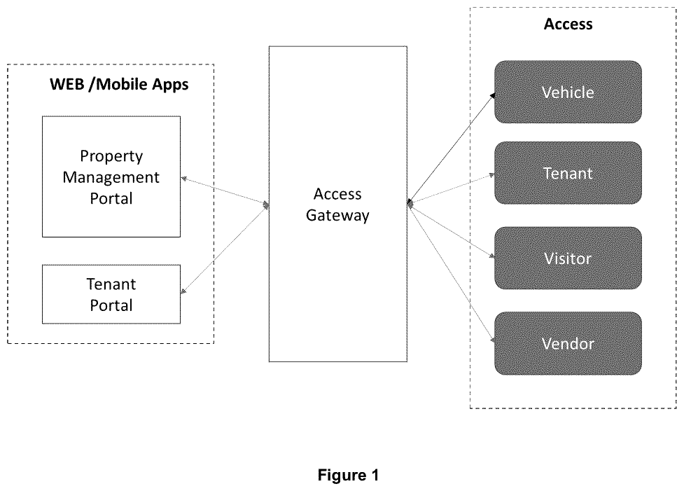

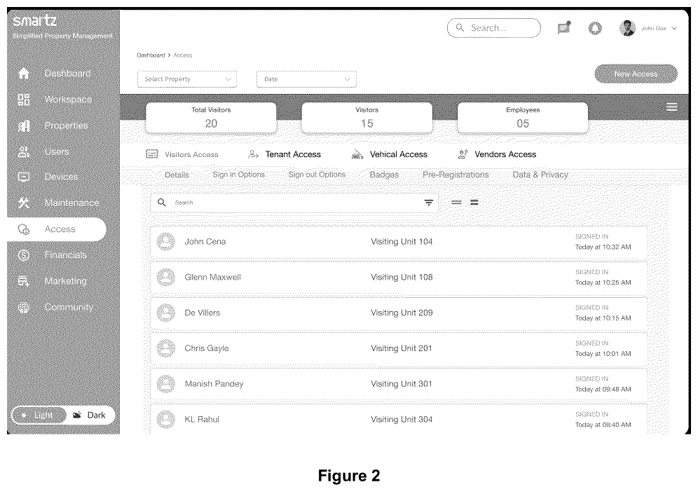

FIG. 1 schematically illustrates an example management portal architecture overview. The architecture overview shows how the management portal and tenant applications communicate to access the gateway to register vehicle ID and tenant biometrics. Management portal applications are device agnostic, and they could be desktop or laptop, web, mobile, or tablet-oriented applications, or something else. A sample application interface is given in FIG. 2.

Any vehicle or person access starts with registering the vehicle ID or person's biometrics in the application portals. The portals will then pass through the access gateway, which works as middleware between application portals and access devices.

The device gateway helps to translate the application communication to the format that the access device needs and vice versa. All of the identity data is stored in the access gateway along with the mapping of the access devices with corresponding properties.

Each access device and/or smart lock contains a unique device ID that needs to first be configured or installed on the access gateway, after which it can be managed to control a device. Whenever a device is added to the network, whether by wireless connection, for example over Wi-Fi, or wired connection, it will communicate with the device gateway to register the device.

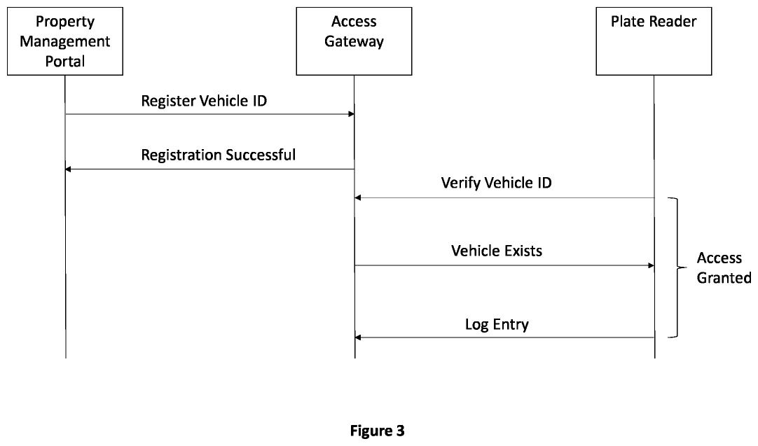

FIG. 3 schematically illustrates an example management portal vehicle access workflow. There are various types of vehicles that may enter a property, but it is desirable that only vehicles that belong to tenants, vendors/contractors, and staff, as well as potentially visitors, should have access to the property via the property management system. Each vehicle is identified based on its car registration number, which could be called its vehicle ID. Vehicle IDs could take or be expressed in a number of forms, including VIN, license plate, permit/pass (including those utilizing wireless communication, such as Bluetooth or RFID, or scannable communication such as magnetic strips or barcodes/QR codes), or the like. Valid vehicle IDs can be added via the property management portal and will be stored in the access gateway.

When a vehicle approaches a vehicle entryway, technology that is deployed on the property premises reads the vehicle ID and sends it to the access gateway. Such technology could be a license plate reader, Bluetooth or RFID reader, or the like. Once the vehicle ID is verified, the access gateway will send a signal back to the necessary deployed access device to grant access to the property via the vehicle entryway. Such access to the property could be allowed or blocked via doors, gates, barricades or the like. It is also contemplated that the system can log pertinent information related to the attempt to gain entry, including the time, date, vehicle entryway, vehicle ID, and whether entry was permitted or denied.

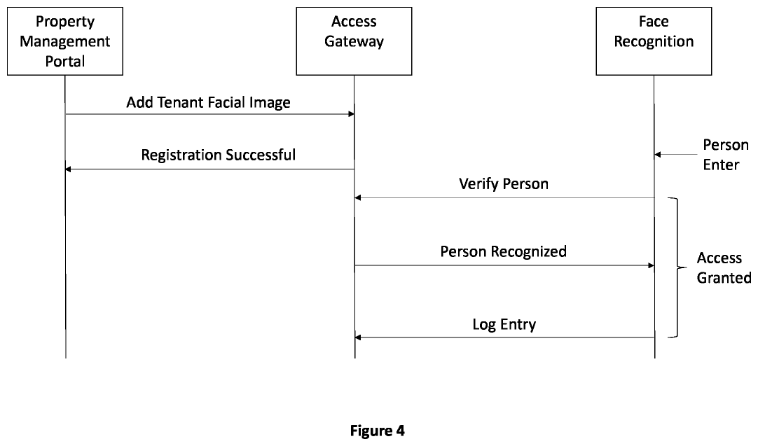

FIG. 4 schematically illustrates an example management portal individual access workflow. Individual (i.e., non-vehicular) access operates in much the same way as vehicle access, with the difference being that individuals need access to a different set of access points, such as unit doors, property entrances, common area doors and the like. Tenants, maintenance personnel, vendors/contractors, and staff, as well as potentially visitors, all constitute categories of individuals for which it may be desired to provide access. Different categories of individuals, such as those specified above, may require different types of access, with examples being one-time, lease time (i.e., during the period of an active lease), specified time, and lifetime access.

Initially, an individual's authorization information would need to be registered to the access gateway either through the management portal or tenant portal. Such authorization information could include biometrics (such as face, retina or fingerprint), or could include other forms of authorization, such as an ID card or pass (including those utilizing wireless communication, such as Bluetooth or RFID, or scannable communication such as magnetic strips or barcodes/QR codes) or passcode. Upon the individual's approach to an access point, the technology at the access point is deployed to read the person's biometrics or other authorizing information and send it back to the access gateway for verification. Such technology could be a facial recognition device, retinal scanner, fingerprint scanner, or the like. Access is granted based on successful verification. Access could be allowed or blocked with, for example, electric door locks serving as access devices. It is also contemplated that the system can log pertinent information related to the attempt to gain entry, including the time, date, door or access point, biometric or other authorizing information scanned, and whether entry was permitted or denied.

What is claimed is:

1. A property access control system for controlling access to a property, comprising: one or more application portals, an access gateway, and one or more access systems.

2. The property access control system of claim 1, wherein the application portal is a property management portal.

3. The property access control system of claim 1, wherein the application portal is a tenant portal.

4. The property access control system of claim 1, wherein the access system comprises a vehicular access system configured to allow vehicular access to the property or a portion thereof.

5. The property access control system of claim 4, wherein the vehicular access system comprises one or more vehicle ID readers configured to identify a vehicle ID, one or more vehicular access points allowing vehicular access to the property or a portion thereof, and one or more vehicular access devices operable to allow or block vehicular access via the one or more vehicular access points.

6. The property access control system of claim 5, wherein the application portal is a property management portal, and wherein the property management portal is configurable to enter permitted vehicle IDs and transmit such permitted vehicle IDs to the access gateway for use by the vehicular access system.

7. The property access control system of claim 6, wherein the one or more vehicle ID readers comprise license plate scanners.

8. The property access control system of claim 1, wherein the access system comprises an individual access system configured to allow individuals access to the property or a portion thereof.

9. The property access control system of claim 8, wherein the individual access system comprises one or more authorization information readers configured to identify an individual's authorization information, one or more individual access points allowing individuals access to the property or a portion thereof, and one or more individual access devices operable to allow or block individual access via the one or more individual access points.

10. The property access control system of claim 9, wherein the application portal is a property management portal, and wherein the property management portal is configurable to enter permitted individuals' authorization information and transmit such permitted individuals' authorization information to the access gateway for use by the individual access system.

11. The property access control system of claim 10, wherein the one or more authorization information readers comprise biometric scanners.

12. The property access control system of claim 1, wherein the access gateway is configurable to interface between the one or more application portals and one or more access systems.

13. A property access control system for controlling access to a property, comprising:
a vehicular access system configured to allow vehicular access to the property or a portion thereof, wherein the vehicular access system comprises one or more vehicle ID readers configured to identify a vehicle ID, one or more vehicular access points allowing vehicular access to the property or a portion thereof, and one or more vehicular access devices operable to allow or block vehicular access via the one or more vehicular access points;
an individual access system configured to allow individuals access to the property or a portion thereof, wherein the individual access system comprises one or more authorization information readers configured to identify an individual's authorization information, one or more individual access points allowing individuals access to the property or a portion thereof, and one or more individual access devices operable to allow or block individual access via the one or more individual access points;
a property management portal, configurable to enter permitted vehicle IDs and permitted individuals' authorization;
a tenant portal; and
an access gateway, wherein the access gateway is configurable to interface between the property management portal, tenant portal, vehicular access system and individual access system, and wherein the access gateway is further configurable to store the permitted vehicle IDs for use by the vehicular access system and the permitted individuals' authorization information for use by the individual access system.

14. The property access control system of claim 13, wherein the one or more vehicle ID readers comprise license plate scanners.

15. The property access control system of claim 13, wherein the one or more authorization information readers comprise biometric scanners.

16. A method of controlling access to a property, comprising the steps of:
entering permitted vehicle IDs into a property management portal;
the property management portal transmitting the permitted vehicle IDs to an access gateway for storage and reference;
a vehicle approaching a vehicular access point of the property seeking access to the property or a portion thereof;
a vehicle ID reader associated with the vehicular access point reading a vehicle ID of the vehicle, and transmitting the vehicle ID to the access gateway;
the access gateway referencing the vehicle ID against stored permitted vehicle IDs, and, based on the results, either transmitting to a vehicular access device associated with the vehicular access point information indicating that access should be granted or that access should be denied;
logging pertinent information associated with the attempt to gain vehicular access.

17. The method of claim 16, further comprising the steps of:
entering permitted individuals' authorization information into the property management portal;
the property management portal transmitting the permitted individuals' authorization information to the access gateway for storage and reference;
an individual approaching an individual access point of the property seeking access to the property or a portion thereof;
an authorization information reader associated with the individual access point reading authorization information of the individual, and transmitting the authorization information to the access gateway;
the access gateway referencing the authorization information against stored permitted individuals' authorization information, and, based on the results, either transmitting to an individual access device associated with the individual access point information indicating that access should be granted or that access should be denied;
logging pertinent information associated with the attempt to gain access.

18. The method of claim 16, wherein the step of the vehicle ID reader associated with the vehicular access point reading the vehicle ID of the vehicle, and transmitting the vehicle ID to the access gateway comprises the step of a license plate scanner associated with the vehicular access point reading a license plate of the vehicle, and transmitting the license plate information to the access gateway.

19. The method of claim 17, wherein the step of the authorization information reader associated with the individual access point reading the authorization information of the individual, and transmitting the authorization information to the access gateway comprises the step of a biometric scanner associated with the individual access point scanning biometric information of the individual, and transmitting the biometric information to the access gateway.
